(19) United States
(12) Patent Application Publication
(10) Pub. No.: US 2018/0104929 A1
(43) Pub. Date: Apr. 19, 2018

(54) TEXTILE COMPOSITE MATERIAL

(71) Applicant: J.H. Ziegler GmbH, Achern (DE)

(72) Inventors: Steffi SCHOENFELDER, Sasbach (DE); Muhammet YILDIRIM, Kappelrodeck (DE); Julia SCHOLZ, Achern-Oberachern (DE)

(21) Appl. No.: 15/566,289

(22) PCT Filed: Apr. 15, 2016
(86) PCT No.: PCT/EP2016/058402

§ 371 Date: Oct. 13, 2017

(30) Foreign Application Priority Data
Apr. 16, 2015 (DE) 10 2015 105 845.6

(51) Int. Cl. B32B 5/02; B32B 5/06; B32B 5/26; B32B 7/12; B32B 9/02; B32B 9/04; D04H 1/498

(52) U.S. Cl. CPC B32B 5/022; B32B 5/06; B32B 5/26; B32B 7/12; B32B 9/025; B32B 2605/08; D04H 1/498; B32B 2250/20; B32B 2262/0276; B32B 2601/00; B32B 2605/003; B32B 9/047

(57) ABSTRACT

A textile composite material for lamination comprises, at least one nonwoven material layer and at least one further nonwoven material layer connected to the at least one nonwoven material layer, wherein the at least one nonwoven material layer and the at least one further nonwoven material layer are mechanically connected to each other, wherein the at least one nonwoven material layer and the at least one further nonwoven material layer each comprise at least one binder fiber, wherein the at least one binder fiber of the at least one further nonwoven material layer has a melting temperature that is equivalent to a value range from 130° C. to 190° C., and the at least one binder fiber of the at least one further nonwoven material layer has a melting temperature that is higher than a melting temperature of the at least one binder fiber of the at least one nonwoven material layer.

### CROSS REFERENCE TO RELATED APPLICATIONS

This application is a U.S. national stage application of PCT/EP2016/058402 filed on Apr. 15, 2016, which claims priority to German Patent Application No. DE 10 2015 105 845.6 filed on Apr. 16, 2015, the contents of which are incorporated herein by reference.

### STATE OF THE ART

The invention relates to a textile composite material according to the preamble of claim 1.

Textile composite materials comprising at least one nonwoven material layer and at least one further nonwoven material layer, which are connected to each other, are already known.

From WO 2010/108562 A1 a textile composite material, in particular a textile composite material for lamination, with at least one nonwoven material layer and with at least one further nonwoven material layer which is connected to the at least one nonwoven material layer, wherein the at least one nonwoven material layer and the at least one further nonwoven material layer are mechanically connected to each other, wherein the at least one nonwoven material layer comprises at least one binder fiber and wherein the at least one further nonwoven material layer comprises at least one binder fiber, and wherein the at least one binder fiber of the at least one further nonwoven material layer has a melting temperature that is equivalent to a value of a value range from 130° C. to 190° C., and that the at least one binder fiber of the at least one further nonwoven material layer has a melting temperature that is higher than a melting temperature of the at least one binder fiber of the at least one nonwoven material layer, is already known.

The objective of the invention is in particular to provide a generic textile composite material featuring a fix connection between the nonwoven material layer and the further nonwoven material layer while maintaining an advantageous drapability, in particular a wrinkle-free arrangeability, of the textile composite material, as well as allowing an advantageous producibility and processing of the textile composite material. The objective is achieved, according to the invention, by the features of claim 1 while advantageous implementations and further developments of the invention may become apparent from the subclaims.

### ADVANTAGES OF THE INVENTION

The invention is based on a textile composite material, in particular a textile composite material for lamination, with at least one nonwoven material layer and with at least one further nonwoven material layer which is connected to the nonwoven material layer, wherein the nonwoven material layer and the further nonwoven material layer are mechanically connected to each other, wherein the at least one nonwoven material layer comprises at least one binder fiber and wherein the at least one further nonwoven material layer comprises at least one binder fiber.

The binder fiber of the at least one further nonwoven material layer has a melting temperature that is equivalent to a value of a value range from 130° C. to 190° C., and that the binder fiber of the at least one further nonwoven material layer has a melting temperature that is higher than a melting temperature of the binder fiber of the at least one nonwoven material layer. It is proposed that individual fibers of the nonwoven material layer completely penetrate the further nonwoven material layer. Preferably the nonwoven material layer and the further nonwoven material layer are each separately implemented as a finished textile product, the finished textile products being, in particular subsequently to individual production of the respective finished textile product, mechanically connected to each other for implementing the textile composite material. By “mechanically connected to each other” is herein in particular a form-fit and/or force-fit connection between at least two elements to be understood, in particular a form-fit and/or force-fit connection between the nonwoven material layer and the further nonwoven material layer. Preferentially the nonwoven material layer and the further nonwoven material layer are mechanically connected to each other without substance-to-substance bond. Especially preferentially, for the purpose of establishing a mechanical connection between the nonwoven material layer and the further nonwoven material layer, fibers of the nonwoven material layer engage into the nonwoven material layer and/or vice versa. The textile composite material is preferably configured to at least partly implement a seat cover, in particular a motor vehicle seat cover. “Configured” is in particular to mean specifically designed and/or specifically equipped. By an element and/or a unit being configured for a certain function is in particular to be understood that the element and/or the unit fulfill/fulfills and/or implement/implements said certain function in at least one application state and/or operating state, or that the element and/or the unit are/is specifically designed for fulfilling said certain function.

The nonwoven material layer is preferably embodied as a finished textile product. The nonwoven material layer preferentially comprises the at least one binder fiber (melt fiber) and at least one functional fiber. The binder fiber of the nonwoven material layer herein in particular has a linear mass density value which is greater than 0.9 dtex, is preferably greater than 5 dtex and is especially preferentially smaller than 15 dtex. Particularly preferably the binder fiber of the nonwoven material layer has a linear mass density value that is equivalent to a value between 1 dtex and 9 dtex. Preferentially the binder fiber of the nonwoven material layer has a melting temperature that is equivalent to a value of a value range from 100° C. to 220° C. Especially preferentially the binder fiber of the nonwoven material layer has a melting temperature that is equivalent to a value of a value range between 130° C. and 180° C.

The functional fiber of the nonwoven material layer is preferably implemented as a polyester fiber, in particular as a polyethylene terephthalate fiber. It is however also conceivable that the functional fiber of the nonwoven material layer is implemented in a different manner that is deemed expedient by someone skilled in the art, e.g. implemented as a polyamide fiber, as a polyolefin fiber, as a polyacrylonitrile fiber, as a polyvinyl chloride fiber, as a polyvinyl alcohol fiber, as a polytetrafluoroethylene fiber, as a polyurethane fiber, or the like. The functional fiber of the nonwoven material layer in particular has a linear mass density value that is greater than 1 dtex, is preferably greater than 15 dtex and is especially preferentially smaller than 30 dtex. Particularly preferably the functional fiber of the nonwoven material layer has a linear mass density value that is equivalent to a value between 1.5 dtex and 24 dtex. The functional fiber of the nonwoven material layer preferably has a great resiliency capability. In particular the functional fiber of the nonwoven material layer is embodied in a spirally crimped fashion. It is however also conceivable that the functional fiber of the nonwoven material layer is implemented in a different manner that is deemed expedient by someone skilled in the art and allows an implementation of a fiber with a great resiliency factor. Especially preferentially the nonwoven material layer comprises a plurality of binder fibers and a plurality of functional fibers, which are mixed up with each other. The binder fibers and/or the functional fibers of the nonwoven material layer may be embodied as spinning fibers (staple fibers) or as filaments (continuous fibers). Due to mix-up, the binder fibers and/or the functional fibers of the nonwoven material layer are preferably interconnected by means of a form-fit connection (by interlacing), by cohesion and/or by adhesion. Herein, for implementing the nonwoven material layer, the binder fibers and/or the functional fibers of the nonwoven material layer may be arranged in an oriented or in a tangled manner. The nonwoven material layer in particular has a basis weight which is greater than 30 g/m², is preferably greater than 60 g/m² and is especially preferentially smaller than 550 g/m². Very particularly preferably the nonwoven material layer has a basis weight which is equivalent to a value of a value range from 50 g/m² to 500 g/m².

The further nonwoven material layer is preferably implemented as a finished textile product, which is in particular producible via a stitch-bonding procedure. The further nonwoven material layer preferentially comprises the at least one binder fiber (melt fiber) and at least one functional fiber. The binder fiber of the further nonwoven material layer herein has in particular a linear mass density value that is greater than 0.9 dtex, is preferably greater than 5 dtex and is especially preferably smaller than 15 dtex. Particularly preferentially the binder fiber of the further nonwoven material layer has a linear mass density value that is equivalent to a value between 1 dtex and 9 dtex. The binder fiber of the further nonwoven material layer preferably has a melting temperature that is equivalent to a value of a value range from 100° C. to 240° C. The binder fiber particularly preferably has a melting temperature that is equivalent to a value of a value range from 130° C. to 190° C. Preferentially the binder fiber (melt fiber) of the further nonwoven material layer has a melting temperature that is higher than a melting temperature of the binder fiber (melt fiber) of the nonwoven material layer. In an alternative embodiment it is also conceivable that the binder fiber (melt fiber) of the further nonwoven material layer features an implementation that is analogous to the implementation of the binder fiber (melt fiber) of the nonwoven material layer.

Preferably the functional fiber of the further nonwoven material layer is implemented as a polyester fiber, in particular as a polyethylene terephthalate fiber. It is however also conceivable that the functional fiber of the further nonwoven material layer is implemented in a different manner that is deemed expedient by someone skilled in the art, e.g. implemented as a polyamide fiber, as a polyolefin fiber, as a polyacrylonitrile fiber, as a polyvinyl chloride fiber, as a polyvinyl alcohol fiber, as a polytetrafluoroethylene fiber, as a polyurethane urethane fiber, as wool or the like, and is in particular implemented, in a manner that is deemed expedient by someone skilled in the art, as a fiber having a textile character (soft-elastic, high rebound force, in particular due to a spirally crimped implementation), and is capable of being processed in a stitch-bonding procedure. The functional fiber of the further nonwoven material layer in particular has a linear mass density value that is greater than 1 dtex, is preferably greater than 15 dtex and is especially preferentially smaller than 30 dtex. Particularly preferably the functional fiber of the further nonwoven material layer has in particular a linear mass density value that is equivalent to a value between 1.5 dtex and 24 dtex. The functional fiber of the further nonwoven material layer preferably has a great resiliency capability. In particular, the functional fiber of the further nonwoven material layer is embodied in a spirally crimped fashion. It is however also conceivable that the functional fiber of the further nonwoven material layer is embodied in a different manner, which is deemed expedient by someone skilled in the art and allows implementing a fiber with a great resiliency capability. Especially preferentially the further nonwoven material layer comprises a plurality of binder fibers and a plurality of functional fibers, which are meshed with each other. The binder fibers and/or the functional fibers of the further nonwoven material layer may be present as spinning fibers (staple fibers) or as filaments (continuous fibers). Due to meshing, the binder fibers and/or the functional fibers of the further nonwoven material layer are preferably connected to each other by way of a form-fit connection (by interlacing).

It is conceivable that the functional fiber/s of the nonwoven material layer and/or of the further nonwoven material layer is/are embodied as hollow fiber/s. Preferably the nonwoven material layer and/or the further nonwoven material layer comprises at least a portion of functional fibers which are embodied as hollow fibers and a portion of functional fibers which are not embodied as hollow fibers. The term “hollow fiber” is herein in particular intended to define a fiber having at least one hollow space, in particular a fiber which, viewed along a longitudinal axis of the fiber, comprises at least one hollow space extending at least substantially along a total length of the fiber, said at least one hollow space being, viewed along at least one circumferential direction running about the longitudinal axis of the fiber, encompassed by at least one envelope of the fiber. The envelope of the fiber may encompass the hollow space in particular in an annulus-shaped, in a trilobal, in a polygonal or in a similar manner. The functional fiber embodied as a hollow fiber preferably has a hollow-space portion of in particular at least more than 1%, preferentially at least more than 5% and especially preferentially at least more than 8% with respect to a total volume portion of the hollow fiber. Particularly preferably the functional fiber embodied as a hollow fiber has a hollow-space portion of less than 15%, in particular in a region around 10%, with respect to a total volume portion of the hollow fiber.

The further nonwoven material layer in particular has a basis weight that is greater than 30 g/m², is preferably greater than 60 g/m² and is particularly preferably smaller than 550 g/m². Especially preferentially the further nonwoven material layer has a basis weight that is equivalent to a value of a value range from 50 g/m² to 500 g/m². In particular the further nonwoven material layer is embodied as a stitch-bonded nonwoven material layer, e.g. as a Malimo® nonwoven material layer, as a Mali nonwoven material layer, as a Multiknit nonwoven material layer, as a Kunit nonwoven material layer, as an Optiknit nonwoven material layer, as a Maliwatt nonwoven material layer, or the like. In case of an imlementation of the further nonwoven material layer as a stitch-bonded nonwoven material layer, e.g. as a Malimo® nonwoven material layer, as a Mali nonwoven material layer, as a Multiknit nonwoven material layer, as a Kunit nonwoven material layer, as an Optiknit nonwoven material layer, as a Maliwatt nonwoven material layer or the like, it is in an alternative embodiment of the textile composite material conceivable that the further nonwoven material layer is connected to the nonwoven material layer chemically and/or thermally, in particular by way of an adhesive bonding process or via a melting procedure.

The further nonwoven material layer in particular has a maximum nonwoven material layer thickness which is smaller than 15 mm, is preferably smaller than 8 mm and is especially preferentially greater than 0.9 mm. Particularly preferably the further nonwoven material layer has a maximum nonwoven material layer thickness that is equivalent to a value of a value range from 1 mm to 10 mm. It is however also conceivable that a ratio of a maximum nonwoven material layer thickness of the further nonwoven material layer to a maximum nonwoven material layer thickness of the nonwoven material layer is at least greater than or equal to 1. A “maximum nonwoven material layer thickness” is herein in particular to mean a maximum extension of a nonwoven material layer, viewed along a direction that runs at least substantially perpendicularly to a main extension surface of the nonwoven material layer, in particular at least substantially perpendicularly to a connecting surface of the nonwoven material layer, said maximum extension being in particular embodied by at least 70%, preferably by at least 80% and particularly preferably by at least 90% of a total number of interconnected fibers of the nonwoven material layer, wherein in particular an entirety of the interconnected fibers, viewed in a cross section, form a polygonal shape, e.g. a rectangle, a square, or the like. Herein in particular individual fibers extending beyond the polygonal shape will not be considered for determining a maximum nonwoven material layer thickness of the nonwoven material layer. The term “substantially perpendicularly” is herein in particular intended to define an orientation of a direction with respect to a reference direction, wherein the direction and the reference direction include, in particular when viewed in a plane, a 90° angle and the angle has a maximum deviation of in particular less than 8°, advantageously less than 5° and especially advantageously less than 2°.

It is conceivable that the textile composite material comprises at least one counterfeit protection unit. The counterfeit protection unit may be connected to the nonwoven material layer and/or to the further nonwoven material layer at least substantially non-releasably. “At least substantially non-releasably” is herein in particular to mean a connection of at least two elements which are separable from each other only with the aid of separating tools, e.g. a saw, in particular a mechanical saw, etc., and/or by chemical separating agents, e.g. solving agents or the like. The counterfeit protection unit may be embodied as an electronic counterfeit protection unit. It is herein conceivable that the counterfeit protection unit comprises at least one counterfeit protection element, which is connected to the nonwoven material layer and/or to the further nonwoven material layer at least substantially non-releasably, and which can be read out via a reading-out device of the counterfeit protection unit. The counterfeit protection element could be embodied as an RFID chip or the like. Further embodiments of the electronical counterfeit protection unit, which are deemed expedient by someone skilled in the art, are also conceivable, e.g. an embodiment as a barcode counterfeit protection unit or the like. It is moreover conceivable that the counterfeit protection unit is embodied, alternatively or additionally, as a mechanical counterfeit protection unit. It is conceivable that, for example, a counterfeit protection element of the counterfeit protection unit, which is embodied as a colored fiber, is incorporated in the nonwoven material layer or that, for example, a counterfeit protection element of the counterfeit protection unit, which is embodied as a fiber glowing under UV light, is incorporated into the nonwoven material layer. Further implementations, which are deemed expedient by someone skilled in the art, are also conceivable.

By the implementation according to the invention, preferably good processing characteristics as well as advantageous producibility of the textile composite material are achievable. Beyond this, the implementation of the textile composite material according to the invention allows achieving an advantageously fix connection between the nonwoven material layer and the further nonwoven material layer while maintaining an advantageous drapability, in particular an at least substantially wrinkle-free arrangeability, of the textile composite material. Furthermore, an additional adhesive agent for connecting the nonwoven material layer and the further nonwoven material layer may advantageously be dispensed with. This allows advantageously providing a textile composite material having good processing characteristics. The textile composite material is advantageously capable of at least substantially adapting to any movement/rounding/bend (convex or concave) of a surface of an object, in particular of a seat on which the textile composite material is arrangeable.

It is further proposed that the nonwoven material layer and the further nonwoven material layer are needled with each other, wherein at least more than 5% of an entire connecting surface of the further nonwoven material layer are pierced by fibers of the nonwoven material layer. The term “needled” is here in particular intended to define a mechanical connection between the nonwoven material layer and the further nonwoven material layer wherein, in a state when the nonwoven material layer is connected to the further nonwoven material layer, at least one fiber, in particular a plurality of fibers, of the nonwoven material layer extends/extend at least partly into the further nonwoven material layer. By an “entire connecting surface of the further nonwoven material layer” is here in particular an entire surface of the further nonwoven material layer to be understood, in particular a surface of the further nonwoven material layer that is projected into a projection plane, which is, in a state when the further nonwoven material layer is connected to the nonwoven material layer, adjacent to the nonwoven material layer. Preferably the nonwoven material layer and the further nonwoven material layer are connected to each other via a needling process. Individual fibers of the nonwoven material layer are preferentially needled into the further nonwoven material layer. Individual fibers of the nonwoven material layer preferably extend into the further nonwoven material layer at least over 5% of the entire connecting surface of the further nonwoven material layer, in particular in such a way that they are distributed over the entire connecting surface, along a direction that extends at least substantially transversely to the connecting surface of the further nonwoven material layer. By “substantially transversely” is herein in particular an orientation of a direction and/or of an axis to be understood, with respect to a reference direction and/or to a reference axis, the orientation of the direction and/or of the axis being at least different from an at least substantially parallel orientation with respect to the reference direction and/or to the reference axis, and being in particular askew or perpendicular to the reference direction and/or to the reference axis.

Preferably the nonwoven material layer and the further nonwoven material layer are needled with each other, wherein a holding force between the nonwoven material layer and the further nonwoven material layer, which acts counter to a nonwoven-nonwoven separating force, is greater than 1 N, in particular due to a form-fit and/or force-fit connection between the fibers of the nonwoven material layer and of the further nonwoven material layer. By a “nonwoven-nonwoven separating force” is herein in particular a force to be understood which acts onto the textile composite material in at least one case of a load and which is capable of inducing a connection between the nonwoven material layer and the further nonwoven material layer to be separated, in particular viewed along a direction extending at least substantially perpendicularly to the connecting surface of the further nonwoven material layer. In particular, a holding force between the nonwoven material layer and the further nonwoven material layer, which acts counter to a nonwoven-nonwoven separating force, is smaller than 1 kN, is preferably smaller than 0.8 kN and is especially preferentially greater than 5 N, in particular determined as indicated in DIN 53357 A. A holding force between the nonwoven material layer and the further nonwoven material layer, which acts counter to a nonwoven-nonwoven separating force, preferably results from the fibers of the nonwoven material layer engaging into the further nonwoven material layer, in particular from a form-fit and/or force-fit connection between the fibers of the nonwoven material layer and of the further nonwoven material layer.

A needling according to the invention allows an especially advantageous and secure connection between the nonwoven material layer and the further nonwoven material layer. Advantageously it is possible to maintain a high level of stability of the further nonwoven material layer after needling with the nonwoven material layer, in particular as the further nonwoven material layer is maintained at least substantially in its basic structure and only some stray fibers of the nonwoven material layer extend into the further nonwoven material layer. Advantageously it is possible, with respect to a state when the further nonwoven material layer is not connected, to at least substantially maintain an elasticity and a lifetime of the further nonwoven material layer.

Especially advantageously it is proposed that the nonwoven material layer and the further nonwoven material layer are needled with each other, wherein at least more than 15% of the entire connecting surface of the further nonwoven material layer are pierced by fibers of the nonwoven material layer. Preferably individual fibers of the nonwoven material layer extend into the further nonwoven material layer at least over 15% of the connecting surface of the further nonwoven material layer, in particular in such a way that they are distributed over the entire connecting surface, along a direction that runs at least substantially transversely to the connecting surface of the further nonwoven material layer. Preferentially the fibers piercing the connecting surface of the further nonwoven material layer are arranged in such a way that they are distributed at least substantially homogeneously on the connecting surface of the further nonwoven material layer. The implementation according to the invention advantageously allows realizing a particularly reliable connection between the nonwoven material layer and the further nonwoven material layer, which is advantageously resistant against an impact of separating forces. Moreover setting back of the textile composite material may advantageously be effected on a further material which is embodied as a leather cutting, advantageously allowing a flat seam at intersection points of several leather cuttings on an object, in particular on a seat which the textile composite material is arrangeable on together with the leather cutting.

It is further proposed that the nonwoven material layer and the further nonwoven material layer are needled with each other, wherein per 1 cm² of the connecting surface of the further nonwoven material layer at least two fibers of the nonwoven material layer enter into the further nonwoven material layer. In particular, per 1 cm² of the connecting surface of the further nonwoven material layer at least three fibers of the nonwoven material layer, preferably at least five fibers of the nonwoven nonwoven material layer and especially preferentially at least ten fibers of the nonwoven material layer enter into the further nonwoven material layer. Very particularly preferably, per 1 cm² of the connecting surface of the further nonwoven material layer more than ten fibers, in particular at least 20 to 300 fibers, of the nonwoven material layer enter into the further nonwoven material layer. The term “enter into the further nonwoven material layer” is herein in particular to mean an arrangement of fibers of the nonwoven material layer with respect to the further nonwoven material layer wherein, in a state when the nonwoven material layer and the further nonwoven material layer are connected, the fibers of the nonwoven material layer extend, starting from the nonwoven material layer, into the further nonwoven material layer. By means of the implementation according to the invention, a secure anchoring of the nonwoven material layer to the further nonwoven material layer is achievable.

It is also proposed that the nonwoven material layer and the further nonwoven material layer are needled with each other, wherein at least a large portion of fibers of the nonwoven material layer entering into the further nonwoven material layer extend into the further nonwoven material layer at least by up to 50% of a maximum nonwoven material layer thickness of the further nonwoven material layer. A “large portion of fibers entering into the further nonwoven material layer” is here in particular to mean at least more than 20%, preferably more than 30% and especially preferentially more than 50% of a total number of fibers of the nonwoven material layer entering into the further nonwoven material layer. It is however also conceivable that individual fibers of the nonwoven material layer extend into the further nonwoven material layer by more than 50% of the maximum nonwoven material layer thickness of the further nonwoven material layer, or completely penetrate the further nonwoven material layer. The term “extend into the further nonwoven material layer at least by 50% of a maximum nonwoven material layer thickness of the further nonwoven material layer” is here in particular to mean that, starting from an edge region of the nonwoven material layer, the fibers of the nonwoven material layer have a protrusion extension, in particular into the further nonwoven material layer, which is equivalent to at least 50% of a maximum nonwoven material layer thickness of the further nonwoven material layer. The implementation according to the invention advantageously allows realizing a particularly fix connection between the nonwoven material layer and the further nonwoven material layer.

It is also proposed that the textile composite material comprises at least one adhesive layer, which is arranged on a side of the further nonwoven material layer that faces away from the nonwoven material layer. It is conceivable that the adhesive layer is embodied as an adhesive nonwoven/adhesive web, as a self-adhesive glue, in particular as a self-adhesive pressure-sensitive glue, or the like. It is moreover conceivable that the adhesive layer is arranged on another side of the nonwoven material layer or of the textile composite material, which is deemed expedient by someone skilled in the art. In an implementation of the adhesive layer as an adhesive nonwoven/adhesive web, the adhesive layer preferably features a reticulate structure and is in particular embodied of a material that is similar to the material of the binder fiber of the nonwoven material layer and/or of the binder fiber of the further nonwoven material layer. In particular, in an implementation as an adhesive nonwoven/adhesive web the adhesive layer has a melting temperature that is equivalent to a value of a value range from 50° C. to 140° C., preferably of a value range from 90° C. to 100° C. By means of the implementation according to the invention, advantageously a secure and simple option is achievable for arranging a further material layer. In particular an especially advantageous option for laminating is realizable.

Furthermore it is proposed that the textile composite material comprises at least one cover layer, which is arranged on a side of the further nonwoven material layer that faces away from the nonwoven material layer. The further nonwoven material layer is, for example, connectable to the cover layer by means of a flatbed lamination machine, by means of a leather fixation machine or by means of another type of machine that is deemed expedient by someone skilled in the art. The cover layer may be embodied as a leather cover layer, as a faux-leather cover layer, as a textile cover layer or as a layer of another type that is deemed expedient by someone skilled in the art. An implementation according to the invention advantageously allows achieving a high surface quality of the textile composite material. Advantageously a textile composite material may be provided which is especially advantageously applicable as part of a seat cover, of an inner door lining of a motor vehicle, or the like.

It is also proposed that, in particular in at least one exemplary embodiment of the textile composite material, the cover layer is mechanically connected to the further nonwoven material layer. Preferably the cover layer is sewn with the further nonwoven material layer. It is however also conceivable that the cover layer is mechanically connected to the further nonwoven material layer via a different method that is deemed expedient by someone skilled in the art. It is however also conceivable that the cover layer is mechanically and/or thermally connected to the further nonwoven material layer via ultrasonic welding or via an embossing process. The implementation according to the invention advantageously allows establishing a connection between the cover layer and the further nonwoven material layer which is both reliable and fix. Advantageously a wear-resistant connection is realizable between the cover layer and the further nonwoven material layer.

Beyond this it is proposed that, in particular in at least one exemplary embodiment of the textile composite material, the cover layer is fixated to the further nonwoven material layer via the adhesive layer. It is furthermore also conceivable that, alternatively or additionally to the adhesive layer, further or additional glue points and/or a glue powder, a meltprint procedure, a hotmelt glue, adhesive foils or other adhesive-bonding measures or adhesive-bonding procedures, in particular hot-melt or cold-melt procedures, deemed expedient by someone skilled in the art, which advantageously in particular maintain a textile character of the textile composite material, are applied for the purpose of connecting the cover layer to the further nonwoven material layer. An implementation according to the invention advantageously allows realizing an easily producible connection between the cover layer and the further nonwoven material layer.

It is moreover proposed that the at least one nonwoven material layer comprises at least one functional fiber having a linear mass density value that is greater than 15 dtex, the at least one binder fiber of the at least one nonwoven material layer having a linear mass density value that is greater than 5 dtex; and/or that the at least one further nonwoven material layer comprises at least one functional fiber having a linear mass density value that is greater than 15 dtex, the at least one binder fiber of the at least one further nonwoven material layer having a linear mass density value that is greater than 5 dtex. This allows achieving advantageous drapability as well as preferably good processing characteristics of the textile composite material.

Furthermore, it is proposed that the at least one nonwoven material layer comprises at least one functional fiber which is embodied as a hollow fiber. In this way an advantageously light-weight implementation of the textile composite material is achievable.

It is also proposed that the at least one nonwoven material layer comprises at least one functional fiber which has a star-shaped, a quadrangular, a trilobal, a horseshoe-shaped or a circle-shaped cross section. In this way an advantageously good adaptation to different requirements is achievable.

Beyond this it is proposed that the cover layer is sewn to the at least one nonwoven material layer and/or to the at least one further nonwoven material layer, as a result of which a preferably simple and reliable connection between the cover layer and the nonwoven material layer and/or the further nonwoven material layer is achievable.

It is further proposed that the textile composite material comprises at least one additional reinforcing layer. This allows achieving an advantageously robust implementation of the textile composite material.

Furthermore it is proposed that the textile composite material comprises at least one additional reinforcing layer which is arranged between the at least one cover layer and the at least one further nonwoven material layer. In this way advantageous drapability as well as a preferably robust implementation of the textile composite material are achievable.

Beyond this, a seat cover with a textile composite material according to the invention is proposed. It is however also conceivable that the textile composite material is utilizable in a different field of application that is deemed expedient by someone skilled in the art, e.g. for an application in the field of furniture, in the field of office equipment, in the field of boat equipment, in the field of airplane equipment, or the like, in which a surface, in particular a lamination, is of importance. The implementation according to the invention allows advantageously achieving a high level of surface quality of a seat covered by the seat cover according to the invention.

The textile composite material according to the invention and/or the seat cover according to the invention are/is herein not to be restricted to the application and implementation form described above. In particular, the textile composite material according to the invention and/or the seat cover according to the invention may, for the purpose of fulfilling a functionality herein described, comprise a number of individual elements, structural components and units that differs from a number that is given here. Moreover, as regards the value ranges indicated in this disclosure, values lying within the limits named are also to be considered as disclosed and as applicable according to requirements.

### DRAWINGS

Further advantages may be gathered from the following description of the drawings. The drawings show exemplary embodiments of the invention. The drawings, the description and the claims contain a plurality of features in combination. Someone skilled in the art will purposefully also consider the features separately and will find further expedient combinations.

It is shown in:

FIG. 1 a sectional view of a textile composite material according to the invention, which comprises at least one nonwoven material layer and a further nonwoven material layer, in a schematic presentation,

FIG. 2 a sectional view of the textile composite material according to the invention, with a cover layer of the textile composite material according to the invention which is arranged at the further nonwoven material layer, in a schematic presentation,

FIG. 3 a sectional view of an alternative textile composite material according to the invention, with a reinforcing layer of the alternative textile composite material, which is arranged between a cover layer and a further nonwoven material layer of the alternative textile composite material according to the invention, in a schematic presentation, and

FIG. 4 a sectional view of a further alternative textile composite material according to the invention, with a cover layer of the alternative textile composite material according to the invention, which is sewn to a further nonwoven material layer of the alternative textile composite material according to the invention, in a schematic presentation.

### DESCRIPTION OF THE EXEMPLARY EMBODIMENTS

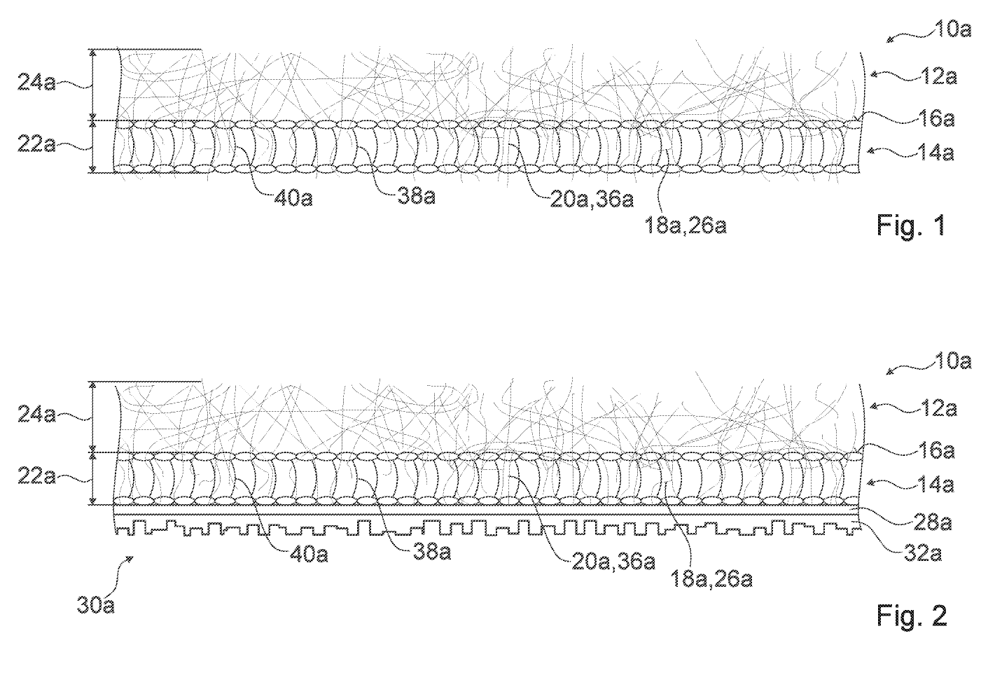

FIG. 1 shows a textile composite material 10a with at least one nonwoven material layer 12a and with at least one further nonwoven material layer 14a which is connected to the nonwoven material layer 12a. The textile composite material 10a is embodied as a seat cover textile composite material. The textile composite material 10a is in particular configured to at least partly implement a seat cover 30a, in particular a motor vehicle seat cover. It is however also conceivable that the textile composite material 10a is configured to implement a different textile object, e.g. to implement an inner door lining of a motor vehicle, to implement an armrest cover, or the like.

The nonwoven material layer 12a is in particular embodied as a finished textile product. The further nonwoven material layer 14a is preferably embodied as a finished textile product, which is in particular producible by a stitch-bonding process. The nonwoven material layer 12a and the further nonwoven material layer 14a are mechanically connected to each other, in particular for at least partly implementing the textile composite material 10a. The nonwoven material layer 12a and the further nonwoven material layer 14a are needled with each other, wherein at least more than 5% of an entire connecting surface 16a of the further nonwoven material layer 14a are pierced by fibers 18a, 20a of the nonwoven material layer 12a. Preferably the nonwoven material layer 12a and the further nonwoven material layer 14a are needled with each other in such a way that at least more than 15% of the entire connecting surface 16a of the further nonwoven material layer 14a are pierced by fibers 18a, 20a of the nonwoven material layer 12a. In particular, per 1 cm² of the connecting surface 16a of the further nonwoven material layer 14a at least two fibers 18a, 20a of the nonwoven material layer 12a enter into the further nonwoven material layer 14a. Preferably per 1 cm² of the connecting surface 16a of the further nonwoven material layer 14a at least ten, in particular between twenty and three hundred fibers 18a, 20a of the nonwoven material layer 12a enter into the further nonwoven material layer 14a. It is however also conceivable that per 1 cm² of the connecting surface 16a of the further nonwoven material layer 14a more than ten, in particular more than three hundred fibers 18a, 20a of the nonwoven material layer 12a enter into the further nonwoven material layer 14a.

Of the fibers 18a, 20a of the nonwoven material layer 12a entering into the further nonwoven material layer 14a, at least a large portion extend into the further nonwoven material layer 14a at least by up to 50% of a maximum nonwoven material layer thickness 22a of the further nonwoven material layer 14a. It is however also conceivable that individual fibers 18a, 20a of the nonwoven material layer 12a or, alternatively, the large portion of the fibers 18a, 20a of the nonwoven material layer 12a, wholly penetrate the further nonwoven material layer 14a. Beyond this it is conceivable that individual fibers 18a, 20a of the nonwoven material layer 12a or, alternatively, the large portion of the fibers 18a, 20a of the nonwoven material layer 12a, extend into the further nonwoven material layer 14a farther than 50% of the maximum nonwoven material layer thickness 22a of the further nonwoven material layer 14a. It is furthermore conceivable that individual fibers 18a, 20a of the nonwoven material layer 12a or, alternatively, the large portion of the fibers 18a, 20a of the nonwoven material layer 12a, extend into the further nonwoven material layer 14a by less than 50% of the maximum nonwoven material layer thickness 22a of the further nonwoven material layer 14a. A ratio of the maximum nonwoven material layer thickness 22a of the further nonwoven material layer 14a to a maximum nonwoven material layer thickness 24a of the nonwoven material layer 12a is herein at least greater than or equal to 1. It is however also conceivable that the textile composite material 10a features a ratio of a maximum nonwoven material layer thickness 22a of the further nonwoven material layer 14a to a maximum nonwoven material layer thickness 24a of the nonwoven material layer 12a that is at least smaller than or equal to 1.

The nonwoven material layer 12a and the further nonwoven material layer 14a are needled with each other in such a way that a holding force between the nonwoven material layer 12a and the further nonwoven material layer 14a acting counter to a nonwoven-nonwoven separating force is greater than 1 N. A mechanical connection of the nonwoven material layer 12a and the further nonwoven material layer 14a is achieved by a needling process in which the fibers 18a, 20a of the nonwoven material layer 12a are needled into the further nonwoven material layer 14a by means of a needling machine (not shown here). As a result of needling the nonwoven material layer 12a and the further nonwoven material layer 14a with one another, the fibers 18a, 20a of the nonwoven material layer 12a establish a form-fit and/or force-fit connection with fibers of the further nonwoven material layer 14a. The nonwoven material layer 12a is in particular connected to the further nonwoven material layer 14a captively, i.e. permanently. The nonwoven material layer 12a and the further nonwoven material layer 14a each have a basis weight that is greater than 45 g/m². It is however also conceivable that the nonwoven material layer 12a and the further nonwoven material layer 14a each have a basis weight that is smaller than or equal to 45 g/m².

The nonwoven material layer 12a comprises at least one functional fiber 26a, which has a linear mass density value that is smaller than or equal to 50 dtex. The functional fiber 26a is in particular implemented by one of the fibers 18a, 20a of the nonwoven material layer 12a. The functional fiber 26a may be embodied as a hollow fiber. The functional fiber 26a may have any cross section that is deemed expedient by someone skilled in the art, e.g. a star-shaped cross section, a quadrangular cross section, a trilobal cross section, a horse-shoe-shaped cross section, an annulus-shaped cross section, or the like. All in all, the nonwoven material layer 12a comprises a plurality of functional fibers 26a which have a linear mass density value smaller than or equal to 50 dtex and which are in particular embodied as hollow fibers.

The nonwoven material layer 12a comprises at least one binder fiber 36a (melt fiber). The binder fiber 36a is implemented by one of the fibers 18a, 20a of the nonwoven material layer 12a. All in all, the nonwoven material layer 12a comprises a plurality of binder fibers 36a. Due to being mixed-up, the binder fibers 36a and/or the functional fibers 26a of the nonwoven material layer 12a are interconnected via a form-fit connection (by interlacing), via cohesion and/or via adhesion. For the purpose of forming the nonwoven material layer 12a, the binder fibers 36a and/or the functional fibers 26a may be arranged in an oriented or in a tangled manner.

The binder fiber 36a of the nonwoven material layer 12a in particular has a linear mass density value that is greater than 0.9 dtex, that is preferably greater than 5 dtex and is especially preferentially smaller than 15 dtex. Particularly preferably the binder fiber 36a of the nonwoven material layer 12a has a linear mass density value that is equivalent to a value between 1 dtex and 9 dtex. Preferably the binder fiber 36a of the nonwoven material layer 12a has a melting temperature that is equivalent to a value of a value range from 100° C. to 220° C. Especially preferentially the binder fiber 36a of the nonwoven material layer 12a has a melting temperature that is equivalent to a value of a value range from 130° C. to 180° C.

The functional fiber 26a of the nonwoven material layer 12a is preferably embodied as a polyester fiber, in particular as a polyethylene terephthalate fiber. It is however also conceivable that the functional fiber 26a of the nonwoven material layer 12a is implemented in a different manner that is deemed expedient by someone skilled in the art, eg. as a polyamide fiber, as a polyolefin fiber, as a polyacrylonitrile fiber, as a polyvinyl chloride fiber, as a polyvinyl alcohol fiber, as a polytetrafluoroethylene fiber, as a polyurethane fiber, or the like. The functional fiber 26a of the nonwoven material layer 12a in particular has a linear mass density value that is greater than 1 dtex, is preferentially greater than 15 dtex and is especially preferentially smaller than 30 dtex. Very particularly preferably the functional fiber 26a of the nonwoven material layer 12a has a linear mass density value that is equivalent to a value between 1.5 dtex and 24 dtex. Preferably the functional fiber 26a of the nonwoven material layer 12a has a high resiliency capability. In particular, the functional fiber 26a of the nonwoven material layer 12a is embodied in a spirally-crimped fashion. It is however also conceivable that the functional fiber 26a of the nonwoven material layer 12a has a different implementation, deemed expedient by someone skilled in the art, which allows an implementation of a fiber with a high resiliency capability.

The further nonwoven material layer 14a preferably comprises at least one binder fiber 38a (melt fiber) and at least one functional fiber 40a. Preferentially the further nonwoven material layer 14a comprises a plurality of binder fibers 38a and/or functional fibers 40a. The binder fiber 38a of the further nonwoven material layer 14a in particular has a linear mass density value that is greater than 0.9 dtex, is preferably greater than 5 dtex and is especially preferentially smaller than 15 dtex. Very particularly preferably the binder fiber 38a of the further nonwoven material layer 14a has a linear mass density value that is equivalent to a value between 1 dtex and 9 dtex. The binder fiber 38a of the further nonwoven material layer 14a preferably has a melting temperature that is equivalent to a value of a value range from 100° C. to 240° C. Especially preferentially the binder fiber 38a of the further nonwoven material layer 14a has a melting temperature that is equivalent to a value of a value range from 130° C. to 190° C. Preferably the binder fiber 38a of the further nonwoven material layer 14a has a melting temperature that is higher than a melting temperature of the binder fiber 36a of the nonwoven material layer 12a. Alternatively, the binder fiber 38a of the further nonwoven material layer 14a may be implemented in a manner that is analogous to the binder fiber 36a of the nonwoven material layer 12a.

The functional fiber 40a of the further nonwoven material layer 14a is preferably implemented as a polyester fiber, in particular as a polyethylene terephthalate fiber. It is however also conceivable that the functional fiber 40a of the further nonwoven material layer 14a is implemented in a different manner that is deemed expedient by someone skilled in the art, eg. as a polyamide fiber, as a polyolefin fiber, as a polyacrylonitrile fiber, as a polyvinyl chloride fiber, as a polyvinyl alcohol fiber, as a polytetrafluoroethylene fiber, as a polyurethane fiber, as wool, or the like, and in particular features a different fiber implementation, deemed expedient by someone skilled in the art, which has a textile character (soft-elastic, high rebound force, in particular due to a spirally-crimped implementation) and is capable of being processed in a stitch-bonding procedure. The binder fibers 38a and/or the functional fibers 40a of the further nonwoven material layer 14a are meshed with each other, and have in particular been meshed already before a connection of the further nonwoven material layer 14a and the nonwoven material layer 12a.

The textile composite material 10a comprises, in particular for partly implementing the seat cover 30a, at least a cover layer 32a which is, in particular in a state when the nonwoven material layer 12a and the further nonwoven material layer 14a are connected to each other, arranged on a side of the further nonwoven material layer 14a that faces away from the nonwoven material layer 12a (FIG. 2). The cover layer 32a is preferably embodied as a leather cover layer. It is however also conceivable that the cover layer 32a is implemented in a different manner deemed expedient by someone skilled in the art, e.g. as a textile cover layer, as a faux-leather cover layer, or the like. For the purpose of connecting the further nonwoven material layer 14a and the cover layer 32a, the textile composite material 10a comprises at least one adhesive layer 28a. In particular in a state when the nonwoven material layer 12a and the further nonwoven material layer 14a are connected to one another, the adhesive layer 28a is arranged on a side of the further nonwoven material layer 14a that faces away from the nonwoven material layer 12a. The adhesive layer 28a may be embodied as an adhesive nonwoven/adhesive web, as a self-adhesive glue, in particular as a self-adhesive, pressure-sensitive glue, or the like. In an implementation of the adhesive layer 28a as an adhesive nonwoven/adhesive web, the adhesive layer 28a preferably has a reticulate structure. The adhesive layer 28a is in particular embodied of a material that is similar or identical to the material of the binder fiber 38a of the further nonwoven material layer 14a. The adhesive layer 28a preferentially has a melting temperature that is equivalent to a value of a value range from 50° C. to 140° C., preferably of a value range from 90° C. to 100 ° C.

In an alternative implementation of the cover layer 32a as a textile cover layer or as a faux-leather cover layer, which is not shown here, the textile composite material 10a may comprise, as an alternative to the adhesive layer 28a, a connection component (not shown here) which is embodied as an additional foam material layer, wherein the connection component may be flame-laminated in both of the implementations mentioned. In an implementation of the connection component as an additional nonwoven material layer, a lost-foam process, which is already known to someone skilled in the art, may be advantageously applicable. Herein the connection component may be arranged on the further nonwoven material layer 14a via flame lamination, and the cover layer 32a, in particular the cover layer 32a implemented as a textile cover layer or as a faux-leather cover layer, may be arranged, via flame lamination, at the connection component, which has already been arranged at the further nonwoven material layer 14a. After the flame lamination, the connection component embodied as an additional nonwoven material layer would be present just as a thin coating. Furthermore it is also conceivable that, alternatively or additionally, glue points and/or glue powders, melt-print procedures, hot-melt glues, adhesive foils or other adhesive-bonding measures or adhesive-bonding procedures deemed expedient by someone skilled in the art, in particular hot-melt or cold-melt adhesive-bonding procedures, which in particular advantageously maintain a textile character of the textile composite material 10a, may be used for connecting the cover layer 32a to the further nonwoven material layer 14a.

The textile composite material 10a advantageously allows a smooth, wrinkle-free arrangement of the textile composite material 10a and/or of the seat cover 30a on difficult seat contours of a seat (not shown here), in particular of a motor vehicle seat, e.g. on a convexly implemented cushioning of a seat, e.g. a lateral wing of an access side of a seat, etc. Moreover, the textile composite material 10a is advantageously highly drapable in minute radii, e.g. in case the textile composite material 10a and/or the seat cover 30a is arranged on a seat in which the textile composite material 10a is formed convex in a partial region of the textile composite material 10a and is formed concave in a further partial region of the textile composite material 10a which directly abuts the partial region. Furthermore the textile composite material 10a is embodied in such a way that it is difficult to ignite in accordance with FMVSS 302, or ISO 3795 respectively. Furthermore, advantageously all relevant documents of the automobile industry should be taken into consideration, e.g. requirements regarding emission/fogging/smell, the end-of-life vehicle regulation, etc., etc.

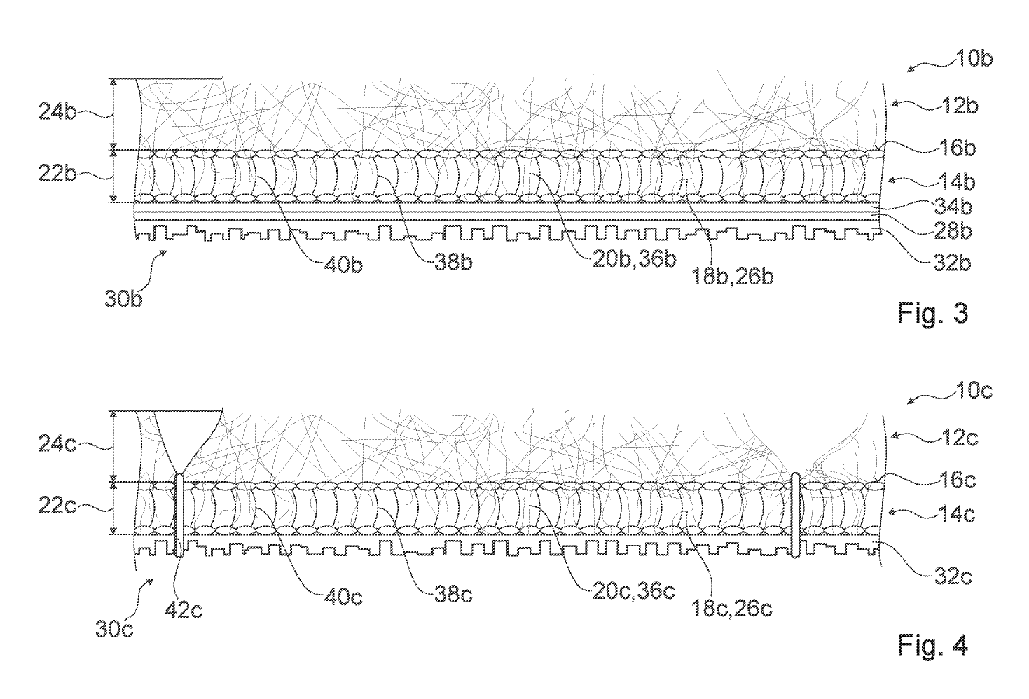

Further exemplary embodiments of the invention are depicted in FIGS. 3 and 4. The following description and the drawings are limited substantially to the differences between the exemplary embodiments, wherein regarding structural components having the same denomination, in particular structural components having the same reference numerals, the drawings and/or the description of the other exemplary embodiments, in particular of FIGS. 1 and 2, may principally be referred to as well. For distinguishing the exemplary embodiments, the letter a has been added to the reference numerals of the exemplary embodiment of FIGS. 1 and 2. In the exemplary embodiments of FIGS. 3 and 4 the letter a has been replaced by the letters b, respectively c.

FIG. 3 shows a textile composite material 10b with at least one nonwoven material layer 12b and with at least one further nonwoven material layer 14b which is connected to the nonwoven material layer 14b. The textile composite material 10b shown in FIG. 3 is implemented in a manner that is at least substantially analogous to the textile composite material 10a depicted in FIGS. 1 and 2. As a difference from the textile composite material 10a shown in FIGS. 1 and 2, the textile composite material 10b shown in FIG. 3 additionally comprises at least one reinforcing layer 34b. The reinforcing layer 34b is configured to reinforce a cover layer 32b of the further nonwoven material layer 14b. In the exemplary embodiment of the textile composite material 10b shown in FIG. 3, the reinforcing layer 34b is embodied as a leather-reinforcing material. It is however also conceivable that the reinforcing layer 34b is embodied in a different manner deemed expedient by someone skilled in the art, in particular in a manner that depends on an implementation of the cover layer 32b. The reinforcing layer 34b is arranged on a side of the further nonwoven material layer 14b that faces away from the nonwoven material layer 12b. The reinforcing layer 34b is arranged between the further nonwoven material layer 14b and the cover layer 32b. In particular, the reinforcing layer 34b is arranged between the further nonwoven material layer 14b and an adhesive layer 28b of the textile composite material 10b. It is however also conceivable that the reinforcing layer 34b is implemented and/or arranged in a different manner deemed expedient by someone skilled in the art. The reinforcing layer 34b may be embodied as a textured material, as a warp-knitted material, as a knitted material, as a lattice, or the like, for cover-layer supporting, in particular for leather supporting. The reinforcing layer 34b is preferably fixatable to the further nonwoven material layer 14b by means of an adhesive web (not shown here). Thus stretching of the cover layer 32b, in particular leather stretching, in case of a load onto the textile composite material 10b may advantageously be at least substantially prevented or at least reduced. Moreover, specially stressed areas of a seat cover 30b comprising the textile composite material 10b, e.g. an outlet point of the seat cover 30b for a lateral airbag, may be provided with appropriate reinforcements. Furthermore, by way of appropriate choice of the reinforcing layer 34b, at least a stretching characteristic, a material characteristic, in particular a maximum tensile force to be endured, etc., of the textile composite material 10b are/is specifically modifiable. In an alternative implementation (not shown here) of the cover layer 32b as a textile cover layer or as a faux-leather cover layer it is moreover conceivable that, in addition to a connection component, a chemical binding agent (not shown here), e.g. a glue, is provided which is arrangeable on the cover layer 32b and/or on the textile composite material 10b. This binding agent may advantageously at least substantially avoid or at least reduce a fiber dust of fibers of the cover layer 32b and/or an adhesion of fiber material of the further nonwoven material layer 14b on the cover layer 32b, in particular subsequently to a curing process of the binding agent. Advantageously a fluff protection is achievable. Regarding further functions and characteristics of the textile composite material 10b shown in FIG. 3, the textile composite material 10a described in the description of FIGS. 1 and 2 may be referred to.

FIG. 4 shows a textile composite material 10c with at least one nonwoven material layer 12c and with at least one further nonwoven material layer 14c which is connected to the nonwoven material layer 12c. The textile composite material 10c depicted in FIG. 4 is implemented in a manner that is at least substantially analogous to the textile composite material 10a shown in FIGS. 1 and 2. As a difference to the textile composite material 10a shown in FIGS. 1 and 2, the textile composite material 10c depicted in FIG. 4 comprises at least one cover layer 32c, which is mechanically connected to the nonwoven material layer 12c and/or to the further nonwoven material layer 14c. The cover layer 32c is sewn to the nonwoven material layer 12c and/or to the further nonwoven material layer 14c. For the purpose of fixating the cover layer 32c to the nonwoven material layer 12c and/or to the further nonwoven material layer 14c, the textile composite material 10c comprises at least one seam connection element 42c. Regarding further functions and characteristics of the textile composite material 10c shown in FIG. 4, the textile composite material 10a described in the description of FIGS. 1 and 2 may be referred to.

1. A textile composite material, in particular a textile composite material for lamination, with at least one nonwoven material layer and with at least one further nonwoven material layer which is connected to the at least one nonwoven material layer , wherein the at least one nonwoven material layer and the at least one further nonwoven material layer are mechanically connected to each other, wherein the at least one nonwoven material layer comprises at least one binder fiber and wherein the at least one further nonwoven material layer comprises at least one binder fiber, wherein the at least one binder fiber of the at least one further nonwoven material layer has a melting temperature that is equivalent to a value of a value range from 130° C. to 190° C., and that the at least one binder fiber of the at least one further nonwoven material layer has a melting temperature that is higher than a melting temperature of the at least one binder fiber of the at least one nonwoven material layer, wherein individual fibers of the nonwoven material layer completely penetrate the further nonwoven material layer.

2. The textile composite material according to claim 1, wherein the at least one nonwoven material layer and the at least one further nonwoven material layer are needled with each other, wherein at least more than 5% of an entire connecting surface of the at least one further nonwoven material layer are pierced by fibers of the at least one nonwoven material layer.

3. The textile composite material according to claim 1, wherein the at least one nonwoven material layer and the at least one further nonwoven material layer are needled with each other, wherein per 1 cm² of a connecting surface of the at least one further nonwoven material layer at least two fibers of the at least one nonwoven material layer enter into the at least one further nonwoven material layer.

4. The textile composite material according to claim 1, wherein the at least one nonwoven material layer and the at least one further nonwoven material layer are needled with each other, wherein at least a large portion of fibers of the at least one nonwoven material layer entering into the at least one further nonwoven material layer extend into the at least one further nonwoven material layer at least by up to 50% of a maximum nonwoven material layer thickness of the at least one further nonwoven material layer.

5. The textile composite material according to claim 1, comprising at least one adhesive layer, which is arranged on a side of the at least one further nonwoven material layer that faces away from the at least one nonwoven material layer.

6. The textile composite material according to claim 1, comprising at least one cover layer, which is arranged on a side of the at least one further nonwoven material layer that faces away from the at least one nonwoven material layer.

7. The textile composite material according to claim 6, wherein the at least one cover layer is mechanically connected to the at least one further nonwoven material layer.

8. The textile composite material according to claim 5, wherein the at least one cover layer is fixated to the at least one further nonwoven material layer via the at least one adhesive layer

9. The textile composite material according to claim 1, wherein the at least one nonwoven material layer comprises at least one functional fiber having a linear mass density value that is greater than 15 dtex, the at least one binder fiber of the at least one nonwoven material layer having a linear mass density value that is greater than 5 dtex; and/or the at least one further nonwoven material layer comprises at least one functional fiber having a linear mass density value that is greater than 15 dtex, the at least one binder fiber of the at least one further nonwoven material layer having a linear mass density value that is greater than 5 dtex.

10. The textile composite material according to claim 1, wherein the at least one nonwoven material layer comprises at least one functional fiber which is embodied as a hollow fiber.

11. The textile composite material according to claim 1 wherein the at least one nonwoven material layer comprises at least one functional fiber which has a star-shaped, a quadrangular, a trilobal, a horseshoe-shaped or a circle-shaped cross section.

12. The textile composite material at least according to claim 7, wherein the at least one cover layer is sewn to the at least one nonwoven material layer and/or to the at least one further nonwoven material layer.

13. The textile composite material according to claim 1, comprising at least one additional reinforcing layer.

14. The textile composite material at least according to claim 6, comprising at least one additional reinforcing layer which is arranged between the at least one cover layer and the at least one further nonwoven material layer.

15. A seat cover with at least one textile composite material according to claim 1.
